(19) United States
(12) Patent Application Publication
(10) Pub. No.: US 2025/0140084 A1
(43) Pub. Date: May 1, 2025

(54) WIRELESS TAG READING APPARATUS, METHOD, AND STORAGE MEDIUM

(71) Applicant: Toshiba Tec Kabushiki Kaisha, Tokyo (JP)

(72) Inventors: Yuichiro KAWABE, Mishima Shizuoka (JP); Haruka OTAKE, Mishima Shizuoka (JP); Wataru SAKURAI, Izu Shizuoka (JP)

(21) Appl. No.: 18/824,863

(22) Filed: Sep. 4, 2024

(30) Foreign Application Priority Data
Nov. 1, 2023 (JP) 2023-187426

(51) Int. Cl. G07G 1/00; G06K 7/10; G07G 1/01

(52) U.S. Cl. CPC G07G 1/009; G06K 7/10356; G06K 7/10425; G07G 1/01

(57) ABSTRACT

A wireless tag reading apparatus includes a housing having an accommodation space in which a shopping cart is placeable, the shopping cart including an upper rack and a lower rack on which one or more items or one or more shopping baskets containing the one or more items are placeable; one or more antennas movable along one or more surfaces of the accommodation space; a communication interface; and a processor configured to when the shopping cart is placed in the accommodation space, control the antennas to move along the surfaces, and read identification information of one or more items in the shopping cart from one or more wireless tags attached thereto, generate item registration information based on the read identification information, and control the communication interface to output the item registration information to a payment device for payment of the items.

### CROSS-REFERENCE TO RELATED APPLICATION

This application is based upon and claims the benefit of priority from Japanese Patent Application No. 2023-187426, filed Nov. 1, 2023, the entire contents of which are incorporated herein by reference.

### FIELD

Embodiments described herein relate generally to a wireless tag reading apparatus, a method, and a storage medium.

### BACKGROUND

There is a known wireless tag reading apparatus that reads wireless tags attached to items placed in a shopping cart.

The wireless tag reading apparatus uses multiple antennas to read, in a single process, multiple wireless tags attached to items placed in a shopping cart.

However, there is no disclosure about a specific configuration of the wireless tag reading apparatus, such as the layout of multiple antennas. For example, since multiple shopping baskets can be placed on a shopping cart, it is necessary to clarify the configuration of a wireless tag reading apparatus for reading wireless tags attached to items placed in the shopping baskets in a single process.

### SUMMARY OF THE INVENTION

Embodiments of the present invention provide a wireless tag reading apparatus, a method, and a storage medium that make it possible to read, in a single process, wireless tags attached to items placed in multiple shopping baskets on a shopping cart.

According to an aspect of the present disclosure, a wireless tag reading apparatus includes a housing having an accommodation space in which a shopping cart is placeable, the shopping cart including an upper rack and a lower rack on which one or more items or one or more shopping baskets containing the one or more items are placeable; one or more antennas movable along one or more surfaces of the accommodation space; a communication interface; and a processor configured to, when the shopping cart is placed in the accommodation space, control the antennas to move along the surfaces, and read identification information from one or more wireless tags attached to one or more items in the shopping cart, generate item registration information based on the read identification information, and control the communication interface to output the item registration information to a payment device for payment of the items.

### BRIEF DESCRIPTION OF THE DRAWINGS

FIG. 1 is a first diagram for describing a method of using a wireless tag reading apparatus according to a first embodiment.

FIG. 2 is a second diagram for describing a method of using the wireless tag reading apparatus according to the first embodiment.

FIG. 3 is a first diagram illustrating a configuration of antennas included in the wireless tag reading apparatus according to the first embodiment.

FIG. 4 is a second diagram illustrating a configuration of the antennas included in the wireless tag reading apparatus according to the first embodiment.

FIG. 5 is a third diagram illustrating a configuration of the antennas included in the wireless tag reading apparatus according to the first embodiment.

FIG. 6 is a first diagram illustrating a function that detects shopping baskets or items and is included in the wireless tag reading apparatus according to the first embodiment.

FIG. 7 is a second diagram illustrating a function that detects shopping baskets or items and is included in the wireless tag reading apparatus according to the first embodiment.

FIG. 8 is a third diagram illustrating a function that detects shopping baskets or items and is included in the wireless tag reading apparatus according to the first embodiment.

FIG. 9 is a block diagram illustrating a hardware configuration of the wireless tag reading apparatus according to the first embodiment.

FIG. 10 is a block diagram illustrating a functional configuration of the wireless tag reading apparatus according to the first embodiment.

FIG. 11 is a flowchart illustrating a process performed by the wireless tag reading apparatus according to the first embodiment.

FIG. 12 is a diagram illustrating a schematic configuration of a wireless tag reading apparatus according to a second embodiment.

FIG. 13 is a block diagram illustrating a hardware configuration of the wireless tag reading apparatus according to the second embodiment.

FIG. 14 is a block diagram illustrating a functional configuration of the wireless tag reading apparatus according to the second embodiment.

FIG. 15 is a flowchart illustrating a process performed by the wireless tag reading apparatus according to the second embodiment.

### DETAILED DESCRIPTION

### First Embodiment

A wireless tag reading device 10 according to a first embodiment of the present disclosure will be described below with reference to the drawings. The present invention is not limited to the embodiment described below.

### (Schematic Configuration of Wireless Tag Reading Apparatus)

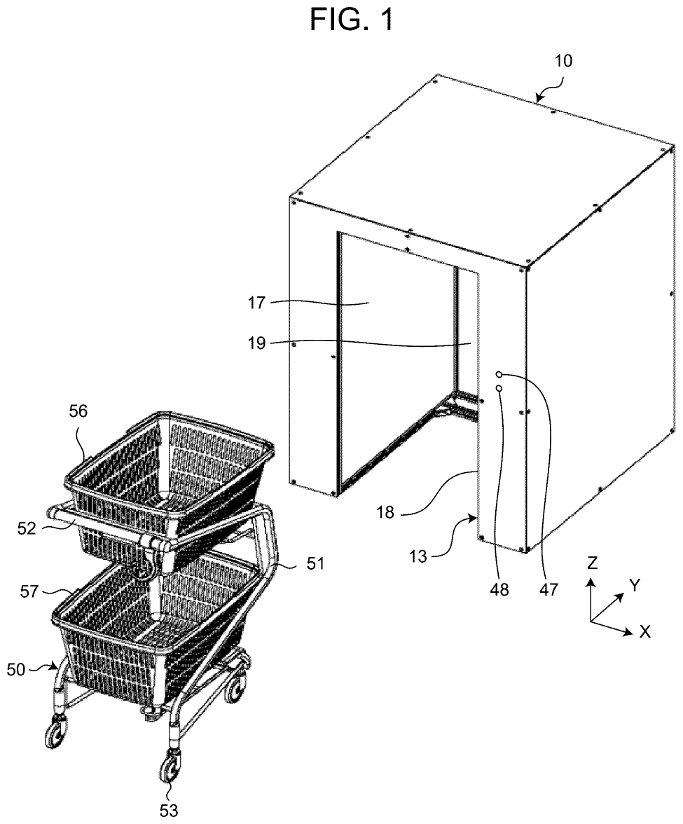

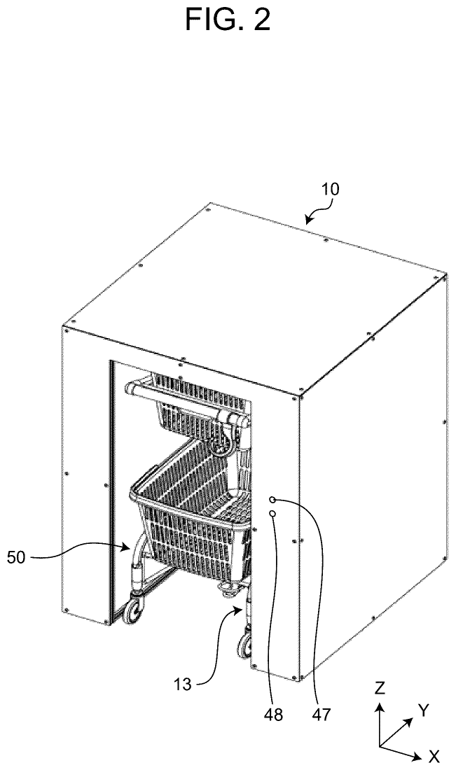

A method of using the wireless tag reading apparatus 10 according to the first embodiment will be described with reference to FIGS. 1 and 2. FIG. 1 is a first diagram for describing a method of using the wireless tag reading apparatus 10 according to the first embodiment. FIG. 2 is a second diagram for describing a method of using the wireless tag reading apparatus 10 according to the first embodiment.

As shown in FIG. 1, the wireless tag reading apparatus 10 has a substantially rectangular parallelepiped shape. An accommodation space 13, in which a shopping cart 50 is to be placed, is formed on a side of the wireless tag reading apparatus 10. The accommodation space 13 is defined by a left side surface 17, a right side surface 18, and a back side surface 19. In the present disclosure, the structure of the wireless tag reading apparatus 10 having the accommodation space 13 is referred to as a housing. That is, the housing of the wireless tag reading apparatus 10 has a substantially rectangular parallelepiped shape and the accommodation space 13 is formed on a side of the housing.

Also, the wireless tag reading apparatus 10 includes a reading start switch 47 and an indicator 48 in the vicinity of the accommodation space 13.

The reading start switch 47 is a switch that is operated after the shopping cart 50 is placed in the accommodation space 13 and starts the reading of item codes registered in RFID tags attached to items placed in shopping baskets 56 and 57 placed on the shopping cart 50. Note that the reading start switch 47 may be replaced with any other type of function or component. For example, the reading of item codes may be automatically started when the wireless tag reading apparatus 10 detects that the shopping cart 50 is placed in the accommodation space 13. Also, a payment device (not shown) may issue an instruction to start the reading.

The indicator 48 is, for example, a light-emitting diode (LED), and is turned on or blinks to indicate operation states of the wireless tag reading apparatus 10. The operation states of the wireless tag reading apparatus 10 includes at least “wireless tag reading in progress” and “wireless tag reading completed”.

The shopping cart 50 includes a frame 51. A handle 52 is provided at the upper end of the frame 51, and casters 53 are provided at the lower end of the frame 51.

The handle 52 is a grip that is gripped when a customer pushes the shopping cart 50.

The casters 53 are small wheels that are provided at the bottom of the shopping cart 50 so that the moving direction of the shopping cart 50 can be freely changed. In general, four casters are provided for the shopping cart 50.

In the shopping cart 50, the shopping basket 56 can be placed on an upper rack, and the shopping basket 57 can be placed on a lower rack. The customer places items to be purchased in the shopping basket 56 and the shopping basket 57 while carrying the shopping cart 50.

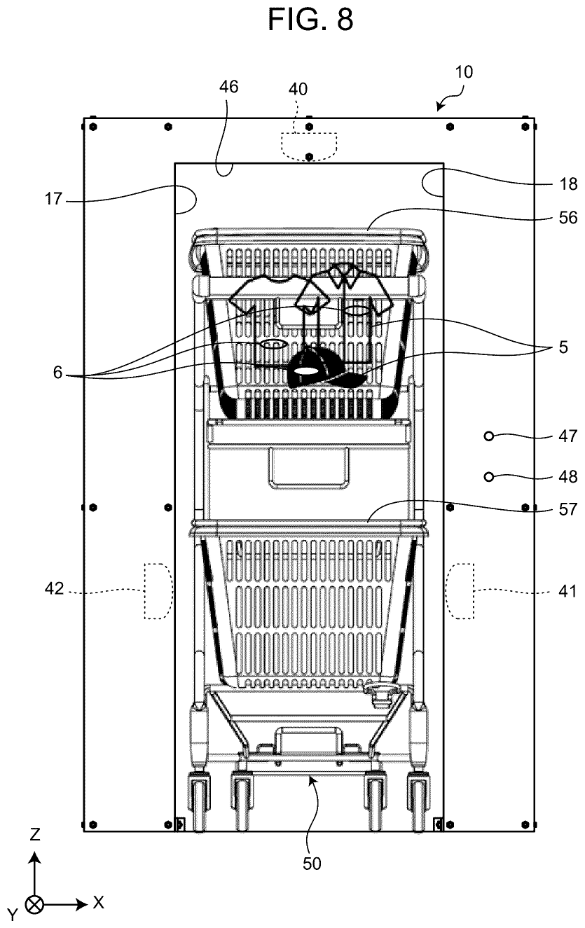

Radio-frequency identification (RFID) tags 6 (see FIG. 8), in which, for example, item codes for identifying items are registered, are attached to items 5 (see FIG. 8). Note that each RFID tag 6 is an example of a wireless tag in the present disclosure.

Note that both of the shopping basket 56 and the shopping basket 57 are not necessarily placed on the shopping cart 50, and only one of the shopping basket 56 and the shopping basket 57 may be placed on the shopping cart 50 according to the need of the customer.

Upon completion of shopping, the customer moves the shopping cart 50 to the location of the wireless tag reading apparatus 10. Then, the customer places the shopping cart 50 in the accommodation space 13 of the wireless tag reading apparatus 10.

FIG. 2 is a diagram illustrating an example of a state in which the shopping cart 50 is placed in the accommodation space 13 of the wireless tag reading apparatus 10. Since the back side surface 19 is formed at the back of the accommodation space 13, the shopping cart 50 being placed in the accommodation space 13 of the wireless tag reading apparatus 10 stops at a position where the front end of the shopping cart 50 contacts the back side surface 19. Hereafter, placing the shopping cart 50 in the accommodation space 13 of the wireless tag reading apparatus 10 may also be simply referred to as placing the shopping cart 50 in the wireless tag reading apparatus 10.

After placing the shopping cart 50 in the wireless tag reading apparatus 10, the customer operates the reading start switch 47 to cause the wireless tag reading apparatus 10 to read item codes of items placed in the shopping basket 56 and the shopping basket 57. The reading of item codes may be started when the reading start switch 47 is operated by the customer or may be started automatically when the wireless tag reading apparatus 10 detects that the shopping cart 50 is placed in the wireless tag reading apparatus 10. Also, an instruction to start the reading may be issued from a payment device.

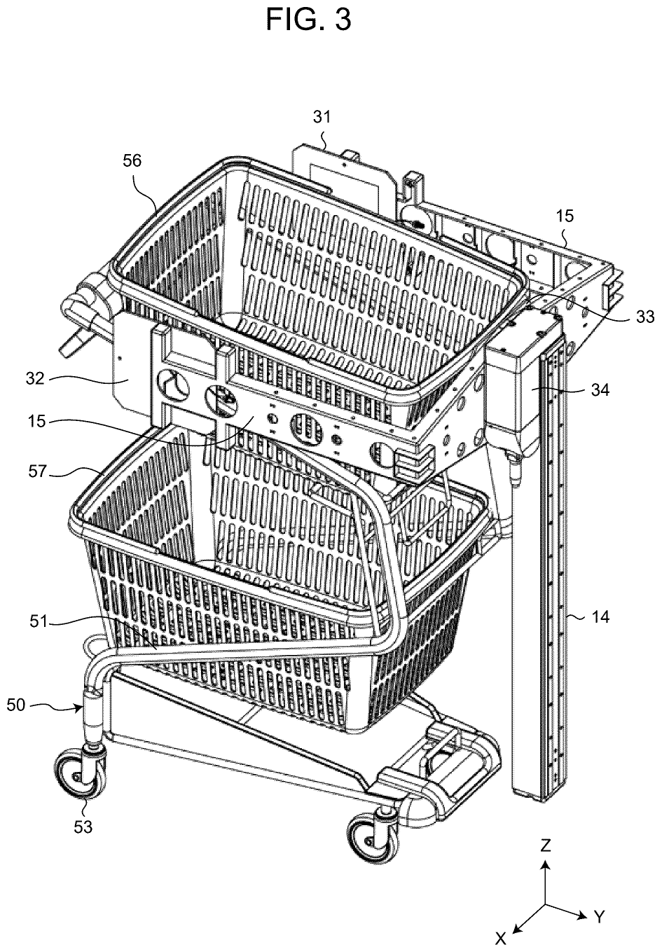

Antennas used by the wireless tag reading apparatus 10 to transmit and receive radio waves to read the RFID tags 6 are provided on the inner sides of the left side surface 17, the right side surface 18, and the back side surface 19 of the wireless tag reading apparatus 10. A configuration of the antennas will be described in detail later (see FIGS. 3, 4, and 5).

### (Configuration of Antennas of Wireless Tag Reading Apparatus)

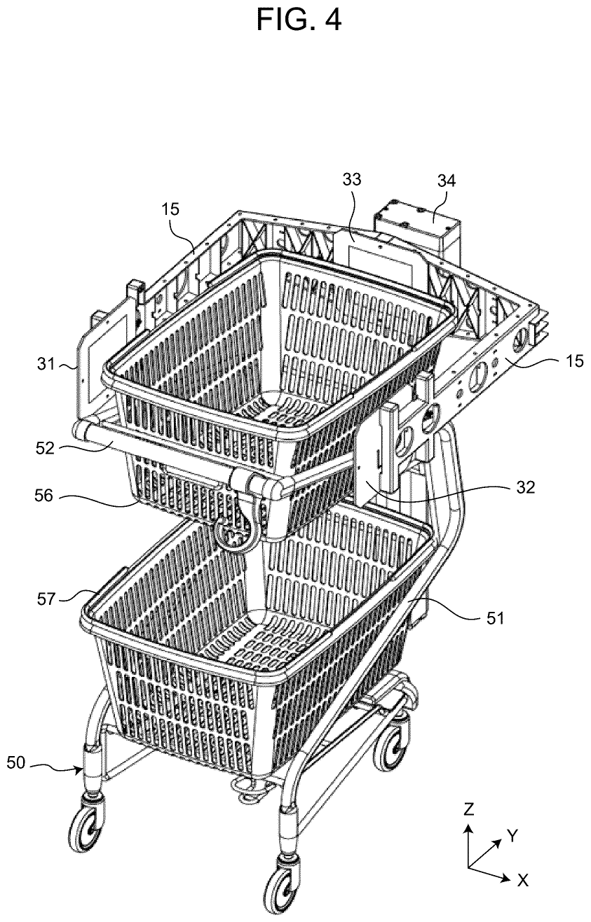

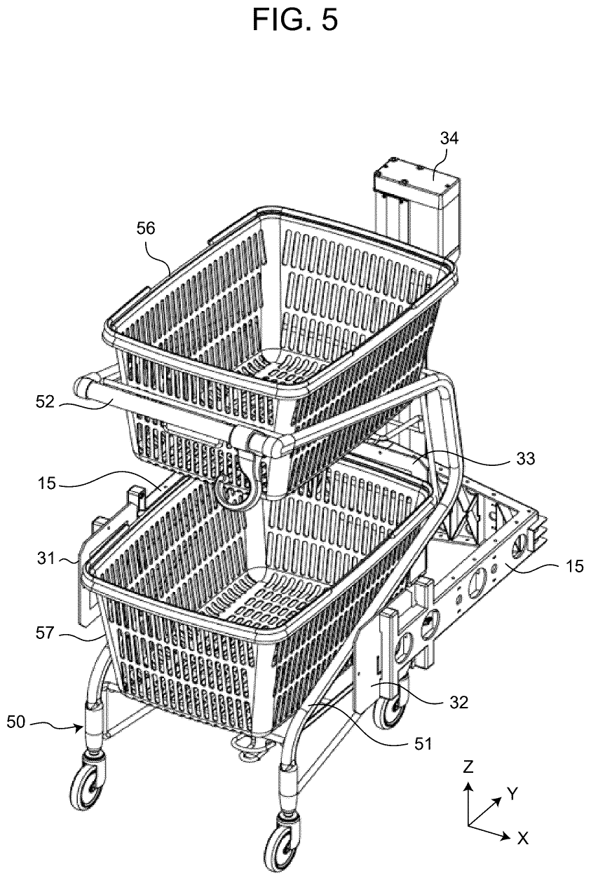

With reference to FIGS. 3, 4, and 5, a configuration of antennas included in the wireless tag reading apparatus 10 will be described. FIG. 3 is a first diagram illustrating a configuration of antennas included in the wireless tag reading apparatus 10 according to the first embodiment. FIG. 4 is a second diagram illustrating a configuration of antennas included in the wireless tag reading apparatus 10 according to the first embodiment. FIG. 5 is a third diagram illustrating a configuration of antennas included in the wireless tag reading apparatus 10 according to the first embodiment.

Antennas that move up and down along the Z-axis are provided on the inner sides of the left side surface 17, the right side surface 18, and the back side surface 19 illustrated in FIG. 1. FIG. 3 and FIG. 4 show the configuration of only a portion of the wireless tag reading apparatus 10 related to the antennas, with the housing of the wireless tag reading apparatus 10 removed.

As shown in FIGS. 3 and 4, an antenna 31 is disposed to the left of the accommodation space 13, that is, on the negative X-axis side. An antenna 32 is disposed to the right of the accommodation space 13, that is, on the positive X-axis side. An antenna 33 is disposed at the back of the accommodation space 13, that is, on the positive Y-axis side. The antennas 31, 32, and 33 transmit radio waves and receive response waves transmitted from the RFID tags 6 in response to the transmitted radio waves.

The antenna 31, the antenna 32, and the antenna 33 are supported by an arm 15 at substantially the same height.

The arm 15 is moved up and down by the driving force of an electric motor 34 along a movement support 14 extending along the Z-axis, i.e., in the vertical direction. The movement support 14 movably supports the arm 15. Note that the arm 15 may be driven by an actuator other than the electric motor 34. The arm 15, the movement support 14, and the electric motor 34 may be collectively referred to as a moving mechanism.

FIG. 3 and FIG. 4 show a state in which the antenna 31, the antenna 32, and the antenna 33 are located in the uppermost position in the Z-axis direction. In this state, radio waves are emitted from the antennas 31, 32, and 33 to read information from the RFID tags 6 attached to the items 5 placed in the shopping basket 56.

FIG. 5 shows a state in which the antenna 31, the antenna 32, and the antenna 33 are located in the lowermost position in the Z-axis direction. In this state, radio waves are emitted from the antennas 31, 32, and 33 to read information from the RFID tags 6 attached to the items 5 placed in the shopping basket 57.

### (Function for Detecting Shopping Baskets or Items)

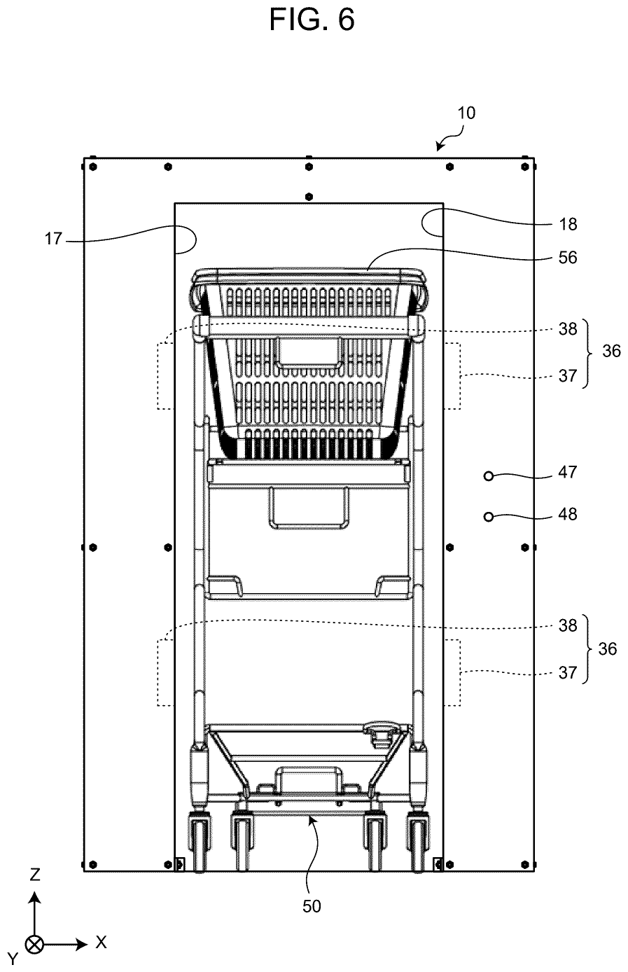

A function of the wireless tag reading apparatus 10 for detecting shopping baskets or items will be described with reference to FIG. 6. FIG. 6 is a first diagram illustrating a function that detects shopping baskets or items and is included in the wireless tag reading apparatus 10 according to the first embodiment.

As described above, the shopping basket 56 is placed on the upper rack of the shopping cart 50, and the shopping basket 57 is placed on the lower rack of the shopping cart 50. However, both of the shopping basket 56 and the shopping basket 57 are not necessarily placed on the shopping cart 50. For example, when only the shopping basket 56 is placed on the upper rack of the shopping cart 50, the wireless tag reading apparatus 10 does not need to move the antennas 31, 32, and 33 from the upper rack to the lower rack and only needs to read the RFID tags 6 at the upper rack of the shopping cart 50. Similarly, when only the shopping basket 57 is placed on the lower rack of the shopping cart 50, the wireless tag reading apparatus 10 does not need to move the antennas 31, 32, and 33 from the upper rack to the lower rack and only needs to read the RFID tags 6 at the lower rack of the shopping cart 50.

The wireless tag reading apparatus 10 of the present embodiment includes a function of detecting whether a shopping basket or an item is placed on each of the upper rack and the lower rack of the shopping cart 50. Note that there is an item (for example, beverages or rice packed in a box) that is placed directly on the shopping cart 50 without being put into a shopping basket. Therefore, the wireless tag reading apparatus 10 detects the presence or absence of shopping baskets or items. When a shopping basket is detected, the wireless tag reading apparatus 10 tries to read the RFID tags 6 at the position of the detected shopping basket even when no item is in the shopping basket.

The wireless tag reading apparatus 10 of the present embodiment includes a photodiode 38, which is a light-receiving element, on the inner side of the left side surface 17 and an LED 37, which is a light-emitting element, on the inner side of the right side surface 18. The LED 37 and the photodiode 38 are disposed to face each other at the same height in the Z-axis direction and at the same depth in the Y-axis direction, and constitute a photo interrupter 36, that is, a transmissive photosensor. The wireless tag reading apparatus 10 includes the photo interrupter 36 at each of positions corresponding to the upper rack and the lower rack of the shopping cart 50.

The photo interrupter 36 is a sensor that is turned on when light emitted from the LED 37 reaches the photodiode 38 and the photodiode 38 generates electricity. When a shopping basket or an item is present between the LED 37 and the photodiode 38, light emitted from the LED 37 is blocked, and the photo interrupter 36 is not turned on. With this configuration, it is possible to detect whether a shopping basket or an item is present on each of the upper rack and the lower rack of the shopping cart 50. Since the frame 51 of the shopping cart 50 blocks light when the photo interrupter 36 operates, the photo interrupter 36 is positioned so as not to overlap the frame 51.

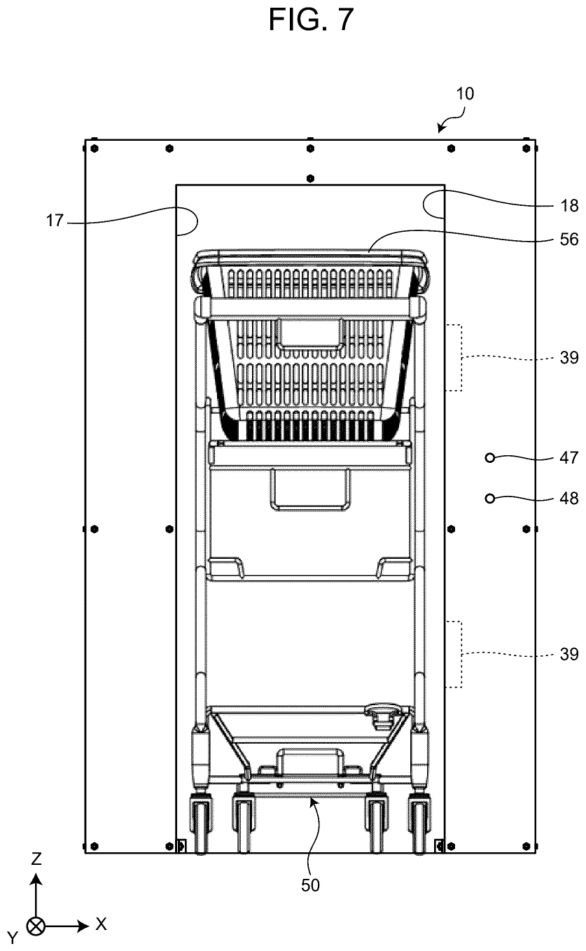

The method of detecting the presence or absence of a shopping basket or an item does not necessarily use the photo interrupter 36. FIG. 7 is a second diagram illustrating a function that detects a shopping basket or an item and is included in the wireless tag reading apparatus 10 according to the first embodiment. FIG. 8 is a third diagram illustrating a function that detects a shopping basket or an item and is included in the wireless tag reading apparatus 10 according to the first embodiment.

The wireless tag reading apparatus 10 illustrated in FIG. 7 includes an ultrasonic sensor 39 on the inner side of the right side surface 18. The wireless tag reading apparatus 10 includes the ultrasonic sensor 39 at each of positions corresponding to the upper rack and the lower rack of the shopping cart 50.

The ultrasonic sensor 39 measures the distance between the ultrasonic sensor 39 and an object by emitting an ultrasonic wave and detecting the intensity of a reflected wave generated when the emitted ultrasonic wave is reflected by the object. Therefore, when a shopping basket or an item is placed on the shopping cart 50 or when an item is placed in a shopping basket, the ultrasonic sensor 39 detects a reflected wave with an intensity higher than that of a reflected wave detected when there is no shopping basket or item. Thus, the ultrasonic sensor 39 detects whether a shopping basket or an item is placed on the shopping cart 50. Since the frame 51 of the shopping cart 50 becomes an obstacle when the ultrasonic sensor 39 operates, the ultrasonic sensor 39 is positioned so as not to overlap the frame 51.

Note that the ultrasonic sensor 39 is an example, and the wireless tag reading apparatus 10 may include any type of proximity sensor having a function of measuring a distance to an object.

The wireless tag reading apparatus 10 illustrated in FIG. 8 includes a camera 42 that is disposed on the inner side of the left side surface 17 and faces a side of the shopping basket 57. Also, the wireless tag reading apparatus 10 includes a camera 41 that is disposed on the inner side of the right side surface 18 and faces a side of the shopping basket 57. Furthermore, the wireless tag reading apparatus 10 includes a camera 40 that is disposed on the inner side of a top plate 46 to face downward toward the shopping basket 56.

The camera 40 captures an image of the shopping basket 56 from above. Then, the wireless tag reading apparatus 10 detects whether an item 5 is present in the shopping basket 56 or whether the shopping basket 56 is present by processing the image captured by the camera 40. As a non-limiting example, a recognition model trained by deep learning may be used for the detection.

The camera 41 and the camera 42 capture images of the shopping basket 57 from the sides. Then, the wireless tag reading apparatus 10 detects whether an item 5 is present in the shopping basket 57 or whether the shopping basket 57 is present by processing the images captured by the cameras 41 and 42. As a non-limiting example, a recognition model trained by deep learning may be used for the detection.

Using the cameras 40, 41, and 42 makes it possible to recognize and distinguish between a shopping basket and an item and makes it possible to recognize an empty shopping basket in which no item is placed. This in turn makes it possible to limit the movement of the antennas 31, 32, and 33 to a range in which one or more shopping baskets containing one or more items are present or a range in which one or more items are directly placed on the shopping cart 50.

The shopping cart 50 may include weight sensors (not shown) at a position where the bottom of the shopping basket 56 contacts the shopping cart 50 and a position where the bottom of the shopping basket 57 contacts the shopping cart 50. The weight sensors communicate with the wireless tag reading apparatus 10 to output detected weights to the wireless tag reading apparatus 10. In this case, the wireless tag reading apparatus 10 can determine whether a shopping basket or an item is placed on each of the upper and lower rack of the shopping cart 50 based on the weights output from the weight sensors and can set the moving range of the antennas 31, 32, and 33 based on the determination result.

### (Hardware Configuration of Wireless Tag Reading Apparatus)

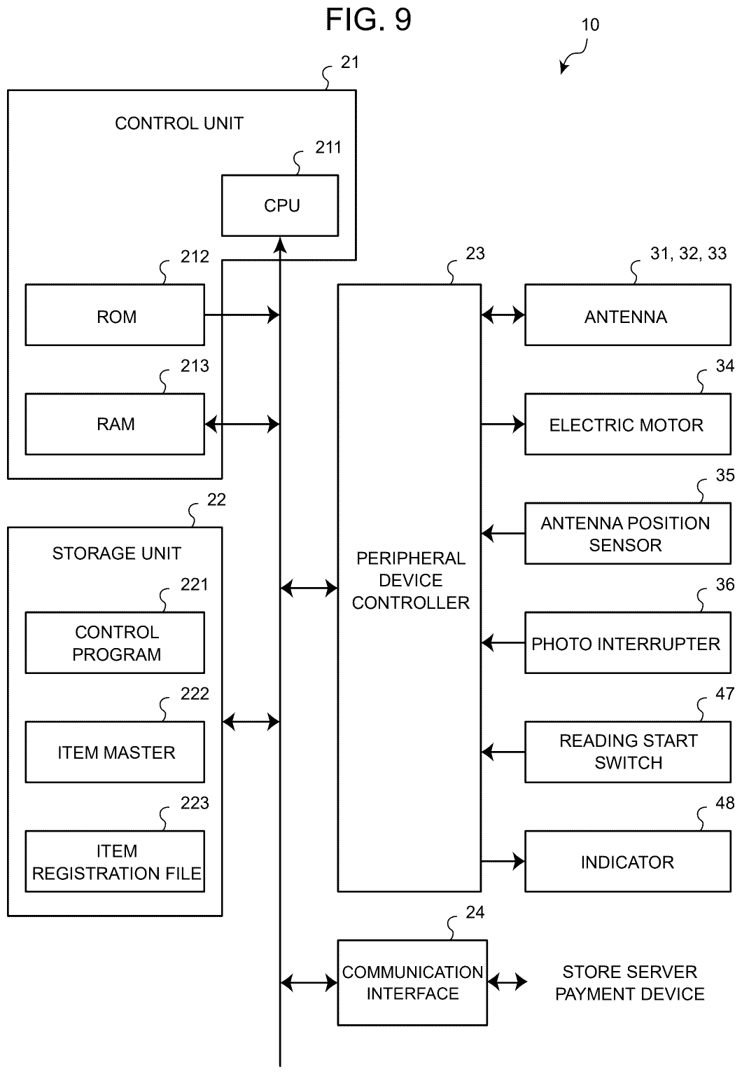

A hardware configuration of the wireless tag reading apparatus 10 will be described with reference to FIG. 9. FIG. 9 is a block diagram illustrating a hardware configuration of the wireless tag reading apparatus 10 according to the first embodiment.

The wireless tag reading apparatus 10 has a configuration in which a control unit 21, a storage unit 22, a peripheral device controller 23, and a communication interface 24 are connected to each other via an internal bus.

The control unit 21 controls the overall operation of the wireless tag reading apparatus 10. The control unit 21 includes a Central Processing Unit (CPU) 211, a Read Only Memory (ROM) 212, and a Random Access Memory (RAM) 213. The CPU 211 is connected to the ROM 212 and the RAM 213 via an internal bus, such as an address bus or a data bus. The CPU 211 loads various programs stored in the ROM 212 and the storage unit 22 into the RAM 213. The CPU 211 controls the operation of the wireless tag reading apparatus 10 according to various programs loaded into the RAM 213. That is, the control unit 21 has a configuration of a general computer and is an example of a processor.

The storage unit 22 is a storage device, such as a Hard Disk Drive (HDD) or a Solid State Drive (SSD). Also, the storage unit 22 may be a non-volatile memory, such as a flash memory, in which stored information is retained even when the power is turned off. The storage unit 22 stores a control program 221, an item master 222, and an item registration file 223.

The control program 221 is a program for controlling the overall operation of the wireless tag reading apparatus 10. The control program 221 may be stored in advance in the storage unit 22 or may be provided in a non-transitory computer-readable storage medium, such as a compact disk read-only memory (CD-ROM), a flexible disk (FD), a CD-recordable (CD-R), or a digital versatile disk (DVD), in an installable format or an executable format. Also, the control program 221 may be stored in a computer connected to a network and downloaded via the network. Furthermore, the control program 221 may be distributed via a network, such as the Internet.

The item master 222 is a master file containing item information, such as item names and prices of items to be sold. The item master 222 contains an item name, a unit price, additional information, and the like in association with each item code. Since the contents of the item master 222 are updated as needed, the wireless tag reading apparatus 10 acquires the latest item master 222 from, for example, a store server via the communication interface 24. In other words, the control unit 21 (or the processor) is configured to control the communication interface 24 to communicate with the store server to update the item master 22 stored in the storage unit 22 (or the storage device).

The item registration file 223 is a file containing item information corresponding to item codes read by the wireless tag reading apparatus 10. The item information contained in the item registration file 223 is used for a checkout process (or a payment process).

The control unit 21 is connected to the antennas 31, 32, and 33, the electric motor 34, an antenna position sensor 35, the photo interrupters 36, the reading start switch 47, and the indicator 48 via the peripheral device controller 23 to input and output various kinds of information.

The antennas 31, 32, and 33 transmit radio waves and receive response waves transmitted from the RFID tags 6 in response to the transmitted radio waves. The number of antennas is not limited to three.

The electric motor 34 moves the arm 15 (see FIG. 3) supporting the antennas 31, 32, and 33 up and down along the movement support 14 (see FIG. 3). The electric motor 34 is, for example, a DC motor or a stepping motor.

The antenna position sensor 35 detects the position of the arm 15 on the movement support 14, that is, the position of the antennas 31, 32, and 33. The antenna position sensor 35 is, for example, a rotary encoder, a potentiometer, or the like that detects the vertical position of the arm 15 based on the amount of rotation corresponding to the vertical movement of the arm 15.

Each of the photo interrupters 36 is a transmissive photo sensor and detects whether a shopping basket or an item is placed on each of the upper rack and the lower rack of the shopping cart 50. Note that the wireless tag reading apparatus 10 may include the ultrasonic sensors 39, the cameras 40, 41, and 42, or the weight sensors instead of the photo interrupters 36. Each of the photo interrupters 36, the ultrasonic sensors 39, the cameras 40, 41, and 42, and the weight sensors is an example of a sensor that detects an item or a shopping basket placed on each of the upper and lower racks of the shopping cart 50.

The reading start switch 47 is a switch operated by a customer after the shopping cart 50 is placed in the accommodation space 13 to instruct the wireless tag reading apparatus 10 to start reading item codes.

The indicator 48 is, for example, an LED and is turned on or blinks to indicate operation states of the wireless tag reading apparatus 10. For example, when the reading start switch 47 is pressed, the indicator 48 is turned on or blinks to indicate that wireless tags (or item codes) are being read. When the reading of wireless tags is completed, the indicator 48 is turned off. The customer confirms that the indicator 48 is turned off and pulls out the shopping cart 50 from the accommodation space 13.

The control unit 21 communicates with a store server and a payment device via the communication interface 24. The store server updates, for example, the item master 222 stored in the wireless tag reading apparatus 10. The payment device acquires the item registration file 223 from the wireless tag reading apparatus 10 and performs a payment process.

### (Functional Configuration of Wireless Tag Reading Apparatus)

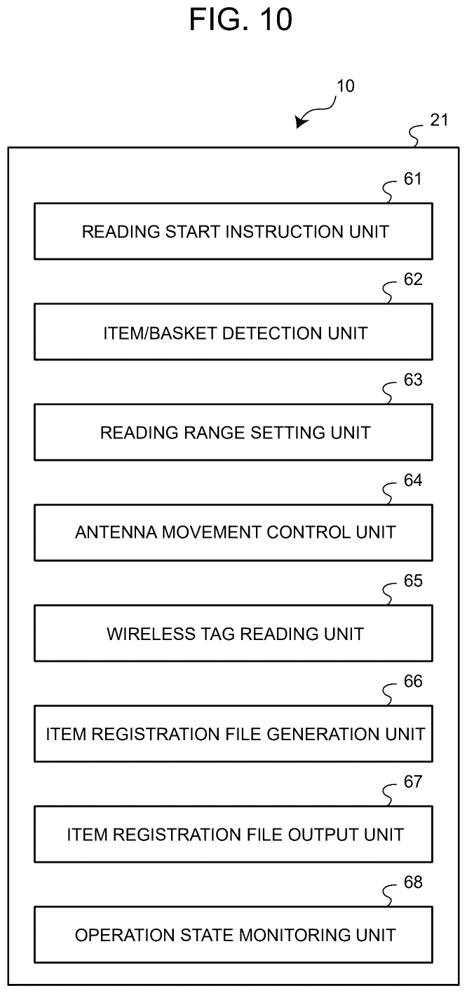

A functional configuration of the wireless tag reading apparatus 10 will be described with reference to FIG. 10. FIG. 10 is a block diagram illustrating a functional configuration of the wireless tag reading apparatus 10 according to the first embodiment.

The control unit 21 of the wireless tag reading apparatus 10 loads the control program 221 into the RAM 213 and executes the control program 221 to implement, as functional units, a reading start instruction unit 61, an item/basket detection unit 62, a reading range setting unit 63, an antenna movement control unit 64, a wireless tag reading unit 65, an item registration file generation unit 66, an item registration file output unit 67, and an operation state monitoring unit 68 shown in FIG. 10. In other words, the control unit 21 (or the processor) is configured to control hardware components of the wireless tag reading apparatus 10 to perform the functions of these functional units. Note that some or all of these functional units may instead be implemented by dedicated hardware.

The reading start instruction unit 61 instructs the wireless tag reading apparatus 10 to start reading the RFID tags 6. Specifically, the reading start instruction unit 61 instructs the wireless tag reading apparatus 10 to start reading the RFID tags 6 upon detecting that the reading start switch 47 has been pressed. In other words, the control unit 21 (or the processor) is configured to control the antennas 31, 32, and 33 to read item codes (or identification information) from the RFID tags 6 upon detecting that the reading start switch 47 has been pressed while the shopping cart 50 is placed in the accommodation space 13.

The item/basket detection unit 62 determines whether an item or a shopping basket is placed on each of the upper rack or the lower rack of the shopping cart 50. The item/basket detection unit 62 determines, for example, whether an item or a shopping basket is placed on each of the upper rack and the lower rack of the shopping cart 50 based on detection results of the photo interrupters 36. Note that the item/basket detection unit 62 is an example of a determination unit in the present disclosure. In other words, the control unit 21 (or the processor) is configured to determine a range in which one or more items or one or more shopping baskets are present based on detection results of the photo interrupters 36 (or the sensor).

The reading range setting unit 63 sets a reading range (or a moving range) in which the antennas 31, 32, and 33 read item codes registered in the RFID tags 6 in accordance with a range that is determined by the item/basket detection unit 62 as including one or more items or shopping baskets. Note that the reading range setting unit 63 is an example of a setting unit in the present disclosure. In other words, the control unit 21 (or the processor) is configured to set a moving range of the antennas 31, 32, and 33 based on the determined range.

The antenna movement control unit 64 drives the electric motor 34 to move the antennas 31, 32, and 33 within the reading range (or a moving range) set by the reading range setting unit 63. Note that the antenna movement control unit 64 is an example of a movement control unit in the present disclosure. In other words, the control unit 21 (or the processor) is configured to control the moving mechanism to move the antennas 31, 32, and 33 within the moving range or in the vertical direction to read item codes (or identification information) from the RFID tags 6. Still in other words, the control unit 21 (or the processor) is configured to control the electric motor 34 (or the actuator) to move the arm 15 along the movement support 14 to read item codes (or identification information) from the RFID tags 6.

In the reading range set by the reading range setting unit 63, the wireless tag reading unit 65 reads response waves transmitted from the RFID tags 6 in response to radio waves transmitted from the antennas 31, 32, and 33. The antennas 31, 32, and 33 transmit radio waves in a time-division manner and read response waves from the RFID tags 6. The wireless tag reading unit 65 is an example of a reading unit in the present disclosure.

Based on item codes in the response waves read by the wireless tag reading unit 65, the item registration file generation unit 66 generates the item registration file 223 in which item information of items corresponding to the item codes is registered. In other words, the control unit 21 (or the processor) is configured to generate the item registration file 223 (or item registration information) based on read item codes (or identification information). Since the multiple antennas 31, 32, and 33 operate in a time-division manner, there is a case in which the same information is read by different antennas from the same RFID tag 6. Therefore, when multiple reading results indicating the same RFID tag 6 are obtained from the wireless tag reading unit 65, the item registration file generation unit 66 merges the reading results into one.

The item registration file output unit 67 outputs the item registration file 223 to the payment device for payment of items. In other words, the control unit 21 (or the processor) is configured to control the communication interface 24 to output the item registration file 223 to the payment device. The item registration file output unit 67 is an example of an output unit in the present disclosure.

The operation state monitoring unit 68 detects an operation state of the wireless tag reading apparatus 10 and causes the indicator 48 to indicate the detected operation state. Examples of operation states include “wireless tag reading in progress” and “wireless tag reading completed”. In other words, the control unit 21 (or the processor) is configured to control the indicator 48 to indicate whether wireless tags are being read or the reading of wireless tags has been completed.

In the configuration described above, the moving range (or the reading range) of the antennas 31, 32, and 33 is set in accordance with the positions of shopping baskets and items detected by the item/basket detection unit 62. Alternatively, the RFID tags 6 may be read while moving the antennas 31, 32, and 33 between the upper rack and the lower rack of the shopping cart 50 regardless of the positions of shopping baskets and items.

### (Process Performed by Wireless Tag Reading Apparatus)

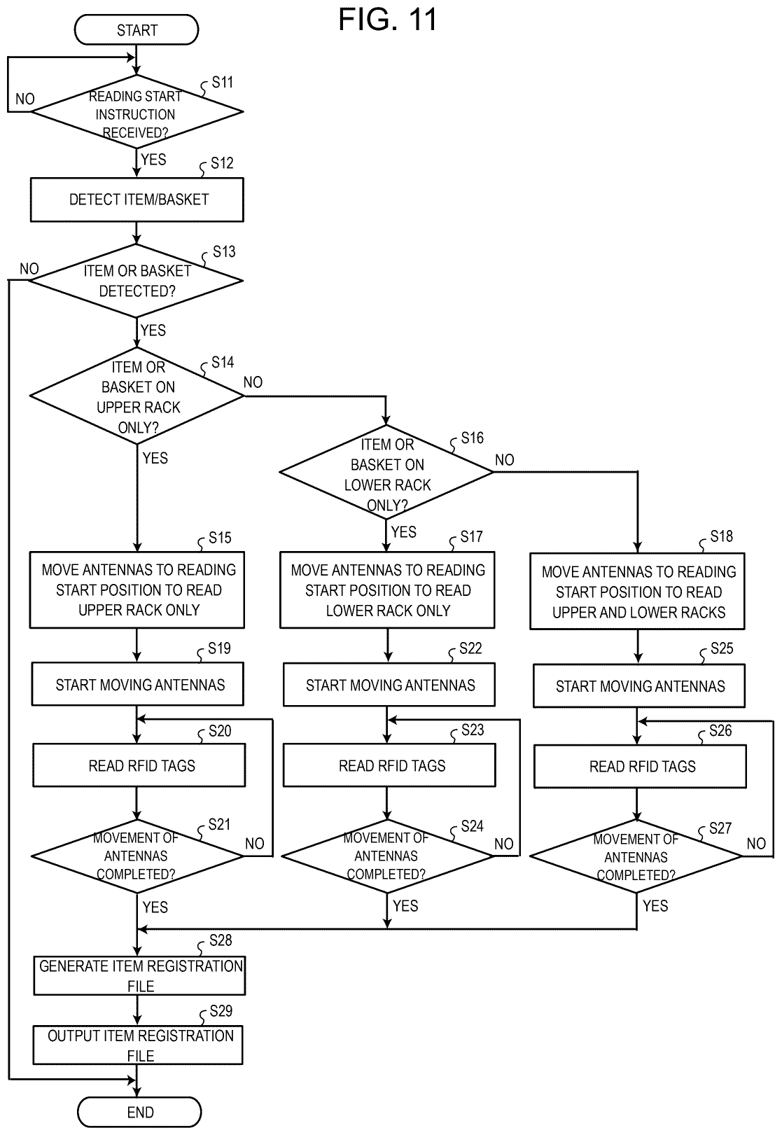

A process performed by the wireless tag reading apparatus 10 will be described with reference to FIG. 11. FIG. 11 is a flowchart illustrating a process performed by the wireless tag reading apparatus 10 according to the first embodiment.

The reading start instruction unit 61 determines whether a reading start instruction to start the reading of the RFID tags 6 has been received (step S11). When it is determined that the reading start instruction has been received (step S11: Yes), the process proceeds to step S12. On the other hand, when it is determined that the reading start instruction has not been received (step S11: No), step S11 is repeated. Note that the reading start instruction unit 61 determines that the reading start instruction has been received upon detecting that the reading start switch 47 has been pressed.

When it is determined at step S11 that the reading start instruction has been received, the item/basket detection unit 62 detects whether one or more items or shopping baskets are placed on the shopping cart 50 (step S12).

The item/basket detection unit 62 determines whether any item or any shopping basket is placed on the shopping cart 50 (step S13). When it is determined that at least one item or shopping basket is placed on the shopping cart 50 (step S13: Yes), the process proceeds to step S14. On the other hand, when it is determined that neither any item nor any shopping basket is placed on the shopping cart 50 (step S13: No), the wireless tag reading apparatus 10 ends the process of FIG. 11.

When it is determined at step S13 that at least one item or shopping basket is placed on the shopping cart 50, the item/basket detection unit 62 determines whether an item or a shopping basket is placed only on the upper rack of the shopping cart 50 (step S14). When it is determined that an item or a shopping basket is placed only on the upper rack of the shopping cart 50 (step S14: Yes), the process proceeds to step S15. On the other hand, when it is determined that an item or a shopping basket is not placed only on the upper rack of the shopping cart 50 (step S14: No), the process proceeds to step S16.

When it is determined at step S14 that an item or a shopping basket is placed only on the upper rack of the shopping cart 50, the reading range setting unit 63 sets the reading range of the RFID tags 6 only to the upper rack of the shopping cart 50. Then, the antenna movement control unit 64 moves the antennas 31, 32, and 33 to a reading starting position (step S15). Then, the process proceeds to step S19.

On the other hand, when it is determined at step S14 that an item or a shopping basket is not placed only on the upper rack of the shopping cart 50, the item/basket detection unit 62 determines whether an item or a shopping basket is placed only on the lower rack of the shopping cart 50 (step S16). When it is determined that an item or a shopping basket is placed only on the lower rack of the shopping cart 50 (step S16: Yes), the process proceeds to step S17. On the other hand, when it is determined that an item or a shopping basket is not placed only on the lower rack of the shopping cart 50 (step S16: No), the process proceeds to step S18.

When it is determined at step S16 that an item or a shopping basket is placed only on the lower rack of the shopping cart 50, the reading range setting unit 63 sets the reading range of the RFID tags 6 only to the lower rack of the shopping cart 50. Then, the antenna movement control unit 64 moves the antennas 31, 32, and 33 to a reading starting position (step S17). Then, the process proceeds to step S22.

On the other hand, when it is determined at step S16 that an item or a shopping basket is not placed only on the lower rack of the shopping cart 50, the reading range setting unit 63 sets the reading range of the RFID tags 6 to the upper rack and the lower rack of the shopping cart 50. Then, the antenna movement control unit 64 moves the antennas 31, 32, and 33 to a reading starting position (step S18). Then, the process proceeds to step S25.

Referring back to step S15, after the antennas 31, 32, and 33 are moved to the reading starting position to read only the upper rack of the shopping cart 50, the antenna movement control unit 64 starts the movement of the antennas 31, 32, and 33 (step S19).

The wireless tag reading unit 65 reads response waves from one or more RFID tags 6 (step S20). The wireless tag reading unit 65 decodes the response waves to acquire item codes.

The antenna movement control unit 64 determines whether the movement of the antennas 31, 32, and 33 has been completed, that is, whether the antennas 31, 32, and 33 have reached a final position for reading only the upper rack of the shopping cart 50 (step S21). When it is determined that the movement of the antennas 31, 32, and 33 has been completed (step S21: Yes), the process proceeds to step S28. On the other hand, when it is determined that the movement of the antennas 31, 32, and 33 has not been completed (step S21: No), the process returns to step S20.

Referring back to step S17, after the antennas 31, 32, and 33 are moved to the reading start position to read only the lower rack of the shopping cart 50, the antenna movement control unit 64 starts the movement of the antennas 31, 32, and 33 (step S22).

The wireless tag reading unit 65 reads response waves from one or more RFID tags 6 (step S23). The wireless tag reading unit 65 decodes the response waves to acquire item codes.

The antenna movement control unit 64 determines whether the movement of the antennas 31, 32, and 33 has been completed, that is, whether the antennas 31, 32, and 33 have reached a final position for reading only the lower rack of the shopping cart 50 (step S24). When it is determined that the movement of the antennas 31, 32, and 33 has been completed (step S24: Yes), the process proceeds to step S28. On the other hand, when it is determined that the movement of the antennas 31, 32, and 33 has not been completed (step S24: No), the process returns to step S23.

Referring back to step S18, after the antennas 31, 32, and 33 are moved to the reading start position to read the upper and lower racks of the shopping cart 50, the antenna movement control unit 64 starts the movement of the antennas 31, 32, and 33 (step S25).

The wireless tag reading unit 65 reads response waves from one or more RFID tags 6 (step S26). The wireless tag reading unit 65 decodes the response waves to acquire item codes.

The antenna movement control unit 64 determines whether the movement of the antennas 31, 32, and 33 has been completed, that is, whether the antennas 31, 32, and 33 have reached a final position for reading the upper and lower racks of the shopping cart 50 (step S27). When it is determined that the movement of the antennas 31, 32, and 33 has been completed (step S27: Yes), the process proceeds to step S28. On the other hand, when it is determined that the movement of the antennas 31, 32, and 33 has not been completed (step S27: No), the process returns to step S26.

When it is determined at each of step S21, step S24, and step S27 that the movement of the antennas 31, 32, and 33 has been completed, the item registration file generation unit 66 compares the item codes included in the response waves read by the wireless tag reading unit 65 with item codes in the item master 222 to generate the item registration file 223 containing item information of items corresponding to the item codes included in the response waves (step S28). In other words, the control unit 21 (or the processor) is configured to compare the item codes (or identification information) read from the RFID tags 6 with item codes (or identification information) in the item master 222 to generate the item registration file 223 (or item registration information) containing item information of the corresponding items.

The item registration file output unit 67 outputs the generated item registration file 223 to the payment device (step S29). Then, the wireless tag reading apparatus 10 ends the process of FIG. 11.

After the process ends, the customer takes out the shopping cart 50 from the wireless tag reading apparatus 10 and performs payment for items to be purchased by using the payment device.

In the embodiment described above, the wireless tag reading apparatus 10 generates the item registration file 223 and outputs the item registration file 223 to the payment device. However, the wireless tag reading apparatus 10 may output only the read item codes to the payment device, and the payment device may generate the item registration file 223.

### Effects of First Embodiment and Variations

As described above, the wireless tag reading apparatus 10 of the first embodiment is configured to accommodate the shopping cart 50 and read identification information from the RFID tags 6 (wireless tags) attached to the items 5 placed in the shopping basket 56 and/or the shopping basket 57 placed on the upper rack and/or the lower rack of the shopping cart 50. The wireless tag reading apparatus 10 includes the antenna movement control unit 64 (or a movement control unit) that moves the antennas 31, 32, and 33 for reading the identification information from the upper rack to the lower rack of the shopping cart 50, the wireless tag reading unit 65 (or a reading unit) that reads response waves transmitted from the RFID tags 6 in response to radio waves transmitted by the antennas 31, 32, and 33 while the antenna 31, 32, and 33 are being moved by the antenna movement control unit 64 in the vertical direction, and the item registration file output unit 67 (or an output unit) that outputs item registration information, which is generated based on the identification information included in the response waves read by the wireless tag reading unit 65, to the payment device used to perform payment for items. This configuration makes it possible to read RFID tags 6 attached to items placed in multiple shopping baskets on the shopping cart 50 in a single process.

The wireless tag reading apparatus 10 according to the first embodiment further includes the item/basket detection unit 62 (or a determination unit) that determines whether one or more items or shopping baskets are placed on the upper rack and/or the lower rack of the shopping cart 50, and the reading range setting unit 63 (or a setting unit) that sets a moving range of the antennas 31, 32, and 33 in accordance with a range that is determined by the item/basket detection unit 62 as including one or more items or shopping baskets. This configuration makes it possible to limit the moving range of the antennas 31, 32, and 33 in accordance with of the positions where items or shopping baskets are placed and thereby makes it possible to reduce the time required for reading the RFID tags 6.

In the example described above, the shopping cart 50 includes the upper and lower racks. However, the configuration of the shopping cart 50 is not limited to this example. As another example, a shopping cart may be configured such that two shopping baskets can be placed on the left and right sides of the shopping cart. In this case, the moving direction of the antennas is the left-right direction. The present disclosure is also applicable to a structure in which two shopping baskets can be placed on the front and rear sides of a shopping cart. In this case, the moving direction of the antennas is the front-rear direction.

### Second Embodiment

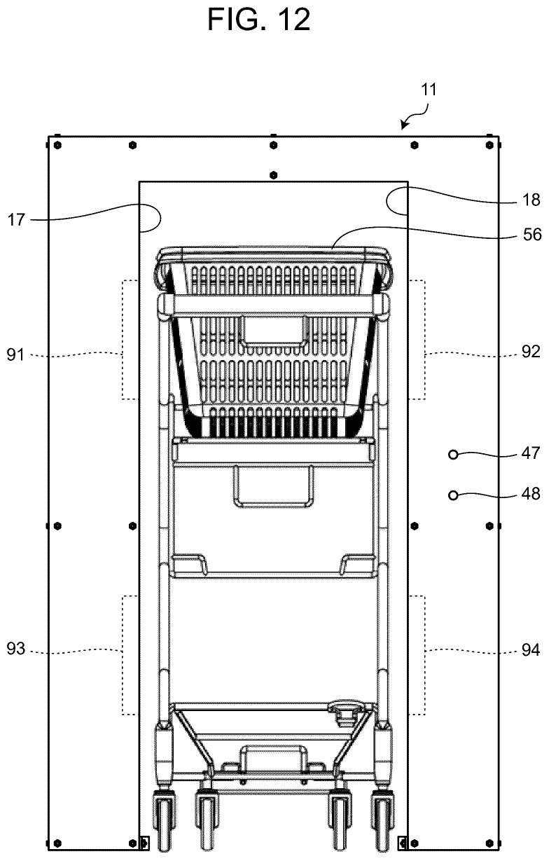

A wireless tag reading apparatus 11 according to a second embodiment of the present disclosure will be described with reference to FIG. 12. FIG. 12 is a diagram illustrating a schematic configuration of the wireless tag reading apparatus 11 according to the second embodiment.

### (Schematic Configuration of Wireless Tag Reading Apparatus)

The wireless tag reading apparatus 11 includes fixed antennas 91, 92, 93, and 94 in the same housing as that of the wireless tag reading apparatus 10 described in the first embodiment, instead of the antennas 31, 32, and 33 and the moving mechanism for moving the antennas 31, 32, and 33 in the vertical direction.

The antenna 91 is disposed on the inner side of the left side surface 17 to face a side of an item or a shopping basket placed on the upper rack of the shopping cart 50.

The antenna 92 is disposed on the inner side of the right side surface 18 to face another side of the item or the shopping basket placed on the upper rack of the shopping cart 50.

The antenna 93 is disposed on the inner side of the left side surface 17 to face a side of an item or a shopping basket placed on the lower rack of the shopping cart 50.

The antenna 94 is disposed on the inner side of the right side surface 18 to face another side of the item or the shopping basket placed on the lower rack of the shopping cart 50. In other words, the antennas 91, 92, 93, and 94 are disposed to face spaces above the upper rack and the lower rack of the shopping cart 50 placed in the accommodation space 13.

Although not shown in FIG. 12, similarly to the wireless tag reading apparatus 10, the wireless tag reading apparatus 11 includes the photo interrupters 36 (see FIG. 6) at positions corresponding to the upper and lower racks of the shopping cart 50. The function of the photo interrupters 36 is as described in the first embodiment. Note that the wireless tag reading apparatus 11 may include, instead of the photo interrupters 36, the ultrasonic sensors 39, the cameras 40, 41, and 42, or the weight sensors described in the first embodiment.

Other configurations of the wireless tag reading apparatus 11 are the same as those of the wireless tag reading apparatus 10.

The wireless tag reading apparatus 11 reads one or more RFID tags 6 attached to one or more items by operating one or more of the antennas 91, 92, 93, and 94 whose reading areas correspond to the positions of items or shopping baskets detected by the photo interrupters 36.

### (Hardware Configuration of Wireless Tag Reading Apparatus)

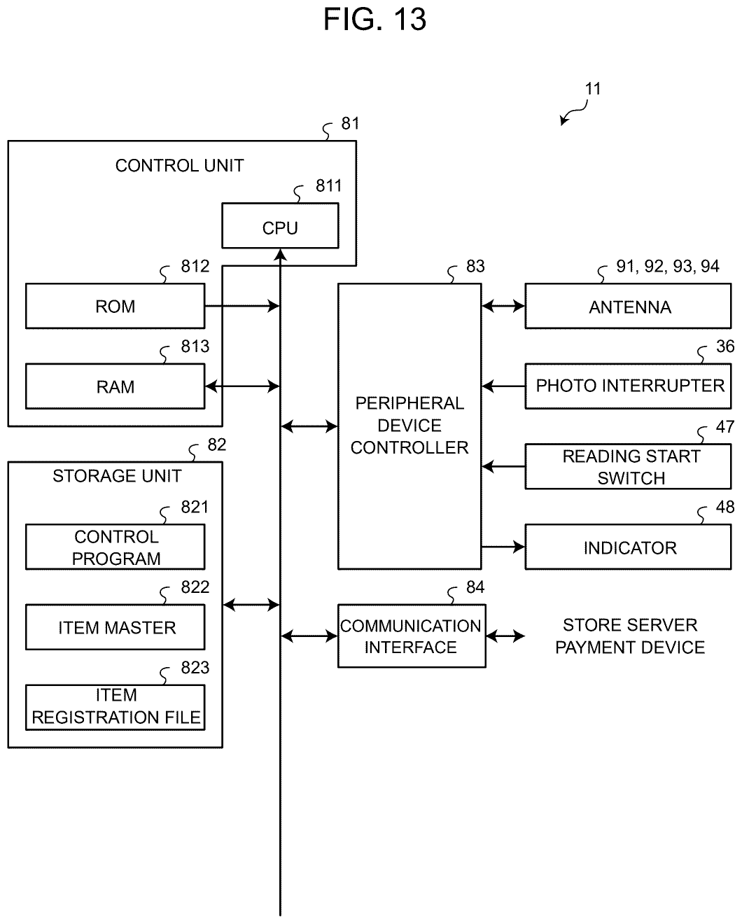

A hardware configuration of the wireless tag reading apparatus 11 will be described with reference to FIG. 13. FIG. 13 is a block diagram illustrating a hardware configuration of the wireless tag reading apparatus 11 according to the second embodiment.

The wireless tag reading apparatus 11 has a configuration in which a control unit 81, a storage unit 82, a peripheral device controller 83, and a communication interface 84 are connected to each other via an internal bus.

The control unit 81 controls the overall operation of the wireless tag reading apparatus 11. The control unit 81 includes a CPU 811, a ROM 812, and a RAM 813. The CPU 811 is connected to the ROM 812 and the RAM 813 via an internal bus, such as an address bus or a data bus. The CPU 811 loads various programs stored in the ROM 812 or the storage unit 82 into the RAM 813. The CPU 811 controls the operation of the wireless tag reading apparatus 11 according to various programs loaded into the RAM 813. That is, the control unit 81 has a configuration of a general computer and is an example of a processor.

The storage unit 82 is a storage device, such as an HDD or an SSD. Also, the storage unit 82 may be a non-volatile memory, such as a flash memory, that retains information even when the power is turned off. The storage unit 82 stores a control program 821, an item master 822, and an item registration file 823.

The control program 821 is a program for controlling the overall operation of the wireless tag reading apparatus 11. The control program 821 may be stored in advance in the storage unit 82 or may be provided in a non-transitory computer-readable storage medium, such as a CD-ROM, a flexible disk (FD), a CD-R, or a DVD, in an installable format or an executable format. Also, the control program 821 may be stored in a computer connected to a network and downloaded via the network. Furthermore, the control program 821 may be distributed via a network, such as the Internet.

The item master 822 is the same as the item master 222 described in the first embodiment.

The item registration file 823 is the same as the item registration file 223 described in the first embodiment.

The control unit 81 is connected to the antennas 91, 92, 93, and 94, the photo interrupters 36, the reading start switch 47, and the indicator 48 via the peripheral device controller 83 to input and output various kinds of information.

The antennas 91, 92, 93, and 94 transmit radio waves and receive response waves transmitted from the RFID tags 6 in response to the transmitted radio waves. The number of antennas is not limited to four.

The photo interrupters 36, the reading start switch 47, and the indicator 48 are as described in the first embodiment.

The control unit 81 communicates with a store server and a payment device via the communication interface 84. The store server updates, for example, the item master 822 stored in the wireless tag reading apparatus 11. The payment device acquires the item registration file 823 from the wireless tag reading apparatus 11 and performs a payment process.

### (Functional Configuration of Wireless Tag Reading Apparatus)

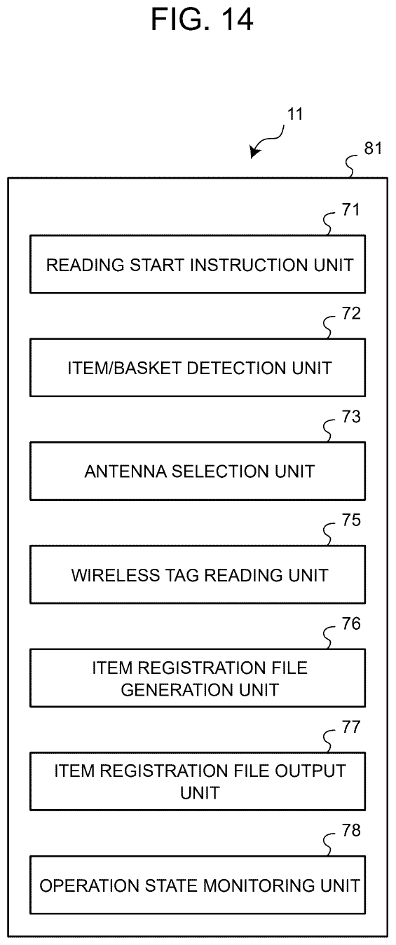

A functional configuration of the wireless tag reading apparatus 11 will be described with reference to FIG. 14. FIG. 14 is a block diagram illustrating a functional configuration of the wireless tag reading apparatus 11 according to the second embodiment.

The control unit 81 of the wireless tag reading apparatus 11 loads the control program 821 into the RAM 813 and executes the control program 821 to implement, as functional units, a reading start instruction unit 71, an item/basket detection unit 72, an antenna selection unit 73, a wireless tag reading unit 75, an item registration file generation unit 76, an item registration file output unit 77, and an operation state monitoring unit 78 illustrated in FIG. 14. In other words, the control unit 81 (or the processor) is configured to control hardware components of the wireless tag reading apparatus 10 to perform the functions of these functional units. Note that some or all of these functional units may be implemented by dedicated hardware.

The reading start instruction unit 71 instructs the wireless tag reading apparatus 11 to start reading the RFID tags 6. Specifically, the reading start instruction unit 71 instructs the wireless tag reading apparatus 11 to start reading the RFID tags 6 upon detecting that the reading start switch 47 has been pressed.

The item/basket detection unit 72 determines whether an item or a shopping basket is placed on each of the upper rack and the lower rack of the shopping cart 50. The item/basket detection unit 72 determines, for example, whether an item or a shopping basket is placed on each of the upper rack and the lower rack of the shopping cart 50 based on detection results of the photo interrupters 36. Note that the item/basket detection unit 72 is an example of a determination unit in the present disclosure. In other words, the control unit 81 (or the processor) is configured to determine a range in which one or more items or one or more shopping baskets are present based on detection results of the photo interrupters 36 (or the sensor).

The antenna selection unit 73 selects one or more of the antennas 91, 92, 93, and 94 used by the wireless tag reading unit 75 to read response waves from one or more RFID tag 6 according to a range that is determined by the item/basket detection unit 72 as including one or more items or shopping baskets. Specifically, the antenna selection unit 73 selects the antennas 91 and 92 when the item/basket detection unit 72 determines that a shopping basket or an item is placed only on the upper rack of the shopping cart 50. The antenna selection unit 73 selects the antennas 93 and 94 when the item/basket detection unit 72 determines that a shopping basket or an item is placed only on the lower rack of the shopping cart 50. Also, the antenna selection unit 73 selects the antennas 91, 92, 93, and 94 when the item/basket detection unit 72 determines that shopping baskets or items are placed on the upper and lower racks of the shopping cart 50. In other words, the control unit 81 (or the processor) is configured to select one or more of the antennas 91, 92, 93, and 94 used to read item codes (or identification information) from one or more wireless tags based on the determined range.

The wireless tag reading unit 75 reads response waves transmitted from the RFID tags 6 in response to radio waves transmitted from the antennas selected by the antenna selection unit 73 from among the antennas 91, 92, 93, and 94 that are disposed to face the shopping baskets 56 and 57 placed on the upper and lower racks of the shopping cart 50. The wireless tag reading unit 75 is an example of a reading unit in the present disclosure.

The item registration file generation unit 76 generates the item registration file 823 containing item information of items corresponding to item codes included in the response waves read by the wireless tag reading unit 75.

The item registration file output unit 77 outputs the item registration file 823 to the payment device for payment of items. The item registration file output unit 77 is an example of an output unit in the present disclosure.

The operation state monitoring unit 78 detects an operation state of the wireless tag reading apparatus 11 and causes the indicator 48 to indicate the detected operation state. Examples of operation states include “wireless tag reading in progress” or “wireless tag reading completed”.

In the configuration described above, the RFID tags 6 are read by operating one or more of the antennas 91, 92, 93, and 94 corresponding to the positions of one or more shopping baskets or items detected by the item/basket detection unit 72. However, all of the antennas 91, 92, 93, and 94 may be operated to read the RFID tags 6 regardless of the positions of detected shopping baskets or items.

### (Process Performed by Wireless Tag Reading Apparatus)

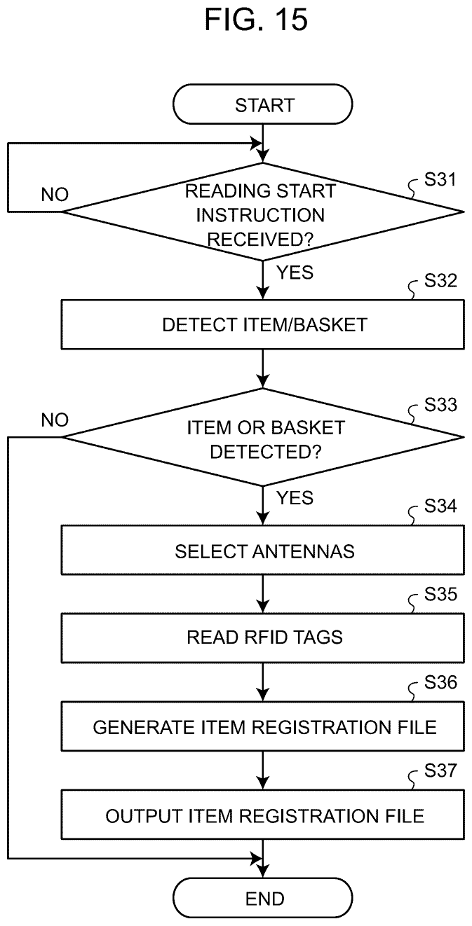

A process performed by the wireless tag reading apparatus 11 will be described with reference to FIG. 15. FIG. 15 is a flowchart illustrating a process performed by the wireless tag reading apparatus 11 according to the second embodiment.

The reading start instruction unit 71 determines whether a reading start instruction to start the reading of the RFID tags 6 has been received (step S31). When it is determined that the reading start instruction has been received (step S31: Yes), the process proceeds to step S32. On the other hand, when it is determined that the reading start instruction has not been received (step S31: No), step S31 is repeated. Note that the reading start instruction unit 71 determines that the reading start instruction has been received upon detecting that the reading start switch 47 has been pressed.

When it is determined at step S31 that the reading start instruction has been received, the item/basket detection unit 72 detects whether one or more items or shopping baskets are placed on the shopping cart 50 (step S32).

The item/basket detection unit 72 determines whether any item or any shopping basket is placed on the shopping cart 50 (step S33). When it is determined that at least one item or shopping basket is placed on the shopping cart 50 (step S33: Yes), the process proceeds to step S34. On the other hand, when it is determined that neither any item nor any shopping basket is placed on the shopping cart 50 (step S33: No), the wireless tag reading apparatus 11 ends the process of FIG. 15.

When it is determined at step S33 that one or more items or shopping baskets are placed on the shopping cart 50, the antenna selection unit 73 selects antennas used to read one or more RFID tags 6 based on the positions of the items or the shopping baskets (step S34).

The wireless tag reading unit 75 reads the RFID tags 6 by operating the antennas selected by the antenna selection unit 73 (step S35).

The item registration file generation unit 76 compares item codes included in response waves read by the wireless tag reading unit 75 with item codes in the item master 822 to generate the item registration file 823 containing item information of items corresponding to the item codes included in the response waves (step S36).

The item registration file output unit 77 outputs the generated item registration file 823 to the payment device (step S37). Then, the wireless tag reading apparatus 11 ends the process of FIG. 15.

After the process ends, the customer takes out the shopping cart 50 from the wireless tag reading apparatus 11 and performs payment for items to be purchased by using the payment device.

In the embodiment described above, the wireless tag reading apparatus 11 generates the item registration file 823 and outputs the item registration file 823 to the payment device. However, the wireless tag reading apparatus 11 may output only the read item codes to the payment device, and the payment device may generate the item registration file 823.

### Effects of Second Embodiment

As described above, the wireless tag reading apparatus 11 of the second embodiment is configured to accommodate the shopping cart 50 and read identification information from the RFID tags 6 (wireless tags) attached to the items 5 placed in the shopping basket 56 and/or the shopping basket 57 placed on the upper rack and/or the lower rack of the shopping cart 50. The wireless tag reading apparatus 11 includes the wireless tag reading unit 75 (or a reading unit) that reads response waves transmitted from the RFID tags 6 in response to radio waves transmitted by the antennas 91, 92, 93, and 94 that read identification information from the RFID tags 6 and are disposed to face the shopping baskets 56 and 57 placed on the upper and lower racks of the shopping cart 50, and the item registration file output unit 77 (or an output unit) that outputs item registration information to the payment device used to perform payment for items. This configuration makes it possible to read the RFID tags 6 attached to items placed in multiple shopping baskets on the shopping cart 50 in a single process.

The wireless tag reading apparatus 11 of the second embodiment further includes the item/basket detection unit 72 (or a determination unit) that determines whether one or more items or shopping baskets are placed on the upper rack and/or the lower rack of the shopping cart 50, and the antenna selection unit 73 (or a selecting unit) that selects antennas for reading response-waves from RFID tags 6 from among the antennas 91, 92, 93, and 94 according to a range that is determined by the item/basket detection unit 72 as including one or more items or shopping baskets. With this configuration, since only antennas selected from among the antennas 91, 92, 93, and 94 are operated to read the RFID tags 6 in accordance with the positions of items or shopping baskets, it is possible to reduce the time required for reading the RFID tags 6.

In the example described above, the shopping cart 50 includes the upper and lower racks. However, the configuration of the shopping cart 50 is not limited to this example. As another example, a shopping cart may be configured such that two shopping baskets can be placed on the left and right sides of the shopping cart. In this case, the antennas are arranged in the left-right direction or configured to be movable in the left-right direction. The present disclosure is also applicable to a structure in which two shopping baskets can be placed on the front and rear sides of a shopping cart. In this case, the antennas are arranged in the front-rear direction or configured to be movable in the front-rear direction.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A wireless tag reading apparatus comprising:
a housing having an accommodation space in which a shopping cart is placeable, the shopping cart including an upper rack and a lower rack on which one or more items or one or more shopping baskets containing the one or more items are placeable;
one or more antennas movable along one or more surfaces of the accommodation space;
a communication interface; and
a processor configured to
when the shopping cart is placed in the accommodation space, control the antennas to move along the surfaces, and read identification information from one or more wireless tags attached to one or more items in the shopping cart,
generate item registration information based on the read identification information, and
control the communication interface to output the item registration information to a payment device for payment of the items.

2. The wireless tag reading apparatus according to claim 1, further comprising:
a moving mechanism that moves the antennas, wherein
the processor is configured to control the moving mechanism to move the antennas in a vertical direction to read the identification information from the one or more wireless tags.

3. The wireless tag reading apparatus according to claim 2, wherein
the moving mechanism includes an arm supporting the antennas, a movement support extending in the vertical direction and movably supporting the arm, and an actuator that moves the arm, and
the processor is configured to control the actuator to move the arm along the movement support to read the identification information from the one or more wireless tags.

4. The wireless tag reading apparatus according to claim 2, further comprising:
a sensor that detects the one or more items or the one or more shopping baskets placed on one or both of the upper rack and the lower rack of the shopping cart, wherein
the processor is configured to
determine a range in which the one or more items or the one or more shopping baskets are present based on a detection result of the sensor,
set a moving range of the antennas based on the determined range, and
control the moving mechanism to move the antennas within the moving range to read the identification information from the one or more wireless tags.

5. The wireless tag reading apparatus according to claim 1, further comprising:
a sensor that detects the one or more items or the one or more shopping baskets placed on one or both of the upper rack and the lower rack of the shopping cart, wherein
the antennas are disposed to face spaces above the upper rack and the lower rack of the shopping cart placed in the accommodation space, and
the processor is configured to
determine a range in which the one or more items or the one or more shopping baskets are present based on a detection result of the sensor, and
select one or more of the antennas used to read the identification information from the one or more wireless tags based on the determined range.

6. The wireless tag reading apparatus according to claim 1, further comprising:
an indicator, wherein
the processor is configured to control the indicator to indicate whether the one or more wireless tags are being read or reading of the one or more wireless tags has been completed.

7. The wireless tag reading apparatus according to claim 1, further comprising:
a storage device that stores an item master storing item information of items in association with identification information of the items, wherein
the processor is configured to compare the read identification information of the one or more items with the identification information in the item master to generate the item registration information containing item information of the one or more items.

8. The wireless tag reading apparatus according to claim 7, wherein
the processor is configured to control the communication interface to communicate with a server to update the item master stored in the storage device.

9. The wireless tag reading apparatus according to claim 1, further comprising:
a switch, wherein
the processor is configured to control the antennas to read the identification information from the one or more wireless tags upon detecting that the switch has been pressed.

10. The wireless tag reading apparatus according to claim 1, wherein
the housing has a substantially rectangular parallelepiped shape, and
the accommodation space is formed on a side of the housing.

11. A method performed by a wireless tag reading apparatus with an accommodation space in which a shopping cart is placeable, the shopping cart including an upper rack and a lower rack on which one or more items or one or more shopping baskets containing the one or more items are placeable, the wireless tag reading apparatus including one or more antennas movable along one or more surfaces of the accommodation space, the method comprising:
when the shopping cart is placed in the accommodation space, moving the antennas along the surfaces, and reading identification information from one or more wireless tags attached to one or more items in the shopping cart;
generating item registration information based on the read identification information; and
outputting the item registration information to a payment device for payment of the items.

12. The method according to claim 11, further comprising:
moving the antennas in a vertical direction to read the identification information from the one or more wireless tags.

13. The method according to claim 12, further comprising:
detecting the one or more items or the one or more shopping baskets placed on one or both of the upper rack and the lower rack of the shopping cart;
determining a range in which the one or more items or the one or more shopping baskets are present based on a result of the detecting; and
setting a moving range of the antennas based on the determined range, wherein
the antennas are moved within the moving range to read the identification information from the one or more wireless tags.

14. The method according to claim 11, wherein
the antennas are disposed to face spaces above the upper rack and the lower rack of the shopping cart placed in the accommodation space; and
the method further comprises:
detecting the one or more items or the one or more shopping baskets placed on one or both of the upper rack and the lower rack of the shopping cart,
determining a range in which the one or more items or the one or more shopping baskets are present based on a result of the detecting, and
selecting one or more of the antennas used to read the identification information from the one or more wireless tags based on the determined range.

15. The method according to claim 11, further comprising:
indicating, with an indicator of the wireless tag reading apparatus, whether the one or more wireless tags are being read or reading of the one or more wireless tags has been completed.

16. The method according to claim 11, wherein
the wireless tag reading apparatus stores an item master storing item information of items in association with identification information of the items, and
the item registration information is generated to include item information of the one or more items by comparing the read identification information of the one or more items with the identification information in the item master.

17. The method according to claim 16, further comprising:
communicating with a server to update the item master stored in the wireless tag reading apparatus.

18. A non-transitory computer-readable storage medium storing a program for causing a processor of a wireless tag reading apparatus to execute a process, a shopping cart being placeable in an accommodation space of the wireless tag reading apparatus, the shopping cart including an upper rack and a lower rack on which one or more items or one or more shopping baskets containing the one or more items are placeable, the wireless tag reading apparatus including one or more antennas movable along one or more surfaces of the accommodation space, the process including:
when the shopping cart is placed in the accommodation space, moving the antennas along the surfaces, and reading identification information from one or more wireless tags attached to one or more items in the shopping cart;
generating item registration information based on the read identification information; and
outputting the item registration information to a payment device for payment of the items.

19. The non-transitory computer-readable storage medium according to claim 18, wherein
the process further includes:
detecting the one or more items or the one or more shopping baskets placed on one or both of the upper rack and the lower rack of the shopping cart,
determining a range in which the one or more items or the one or more shopping baskets are present based on a result of the detecting,
setting a moving range of the antennas based on the determined range, and
moving the antennas within the moving range to read the identification information from the one or more wireless tags.

20. The non-transitory computer-readable storage medium according to claim 18, wherein
the antennas are disposed to face spaces above the upper rack and the lower rack of the shopping cart; and
the process further includes:
detecting the one or more items or the one or more shopping baskets placed on one or both of the upper rack and the lower rack of the shopping cart,
determining a range in which the one or more items or the one or more shopping baskets are present based on a result of the detecting, and
selecting one or more of the antennas used to read the identification information from the one or more wireless tags based on the determined range.
